(19) United States
(12) Patent Application Publication
(10) Pub. No.: US 2012/0134344 A1
(43) Pub. Date: May 31, 2012

(54) Scheduling In Radio Telecommunication System

(76) Inventors: Ling Yu, Oulu (FI); Vinh Van Phan, Oulu (FI); Kari Veikko Horneman, Oulu (FI)

(21) Appl. No.: 13/389,114

(22) PCT Filed: Aug. 7, 2009
(86) PCT No.: PCT/EP09/60287

§ 371 Date: Feb. 6, 2012

(51) Int. Cl. H04W 74/04; H04W 72/04; H04J 3/00

(52) U.S. Cl. 370/336

(57) ABSTRACT

A method, apparatus, and computer program is provided for controlling direct device-to-device communication between a first and at least a second terminal device on a shared communication channel also used for communication with a base station. The base station schedules the utilization of the shared communication channel to terminal devices communicating with the base station and terminal devices communicating directly with one another.

### FIELD

The invention relates to the field of cellular radio telecommunications and, particularly, to scheduling transmission on a shared communication channel.

### BACKGROUND

Modern cellular telecommunication systems and terminal devices of such systems are capable of supporting device-to-device communication capabilities for efficient and cost-effective content delivery, network operation and performance. Two terminals located relatively close to each other in the same cell may be configured by the network to communicate over a direct connection instead of routing the data through a cellular network. Scheduling transmissions to such device-to-device connections poses challenges in designing the network operation and signaling mechanisms.

### BRIEF DESCRIPTION

According to an aspect of the present invention, there is provided a method as specified in claim 1.

According to another aspect of the present invention, there is provided an apparatus as specified in claim 11.

According to another aspect of the present invention, there is provided an apparatus as specified in claim 21.

According to another aspect of the present invention, there is provided a base station as specified in claim 22.

According to another aspect of the present invention, there is provided a terminal device as specified in claim 23.

According to another aspect of the present invention, there is provided an apparatus as specified in claim 24.

According to yet another aspect of the present invention, there is provided a computer program product embodied on a physical carrier medium as specified in claim 25.

Embodiments of the invention are defined in the dependent claims.

### LIST OF DRAWINGS

Embodiments of the present invention are described below, by way of example only, with reference to the accompanying drawings, in which

FIG. 1 illustrates a communication environment to which embodiments of the invention may be applied;

FIG. 2 illustrates basic operation of a method according to an embodiment of the invention;

FIG. 3 illustrates scheduling of shared communication resources according to an embodiment of the invention;

FIGS. 4 to 6 are signaling diagrams illustrating embodiments of the invention for communicating scheduling messages from a base station to terminal devices;

FIG. 7 is a signaling diagram illustrating an embodiment where a terminal device receives a scheduling message on behalf of another terminal device;

FIG. 8 is a block diagram of an apparatus applicable to a base station according to an embodiment of the invention; and

FIG. 9 is a block diagram of an apparatus applicable to a terminal device according to an embodiment of the invention.

### DESCRIPTION OF EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

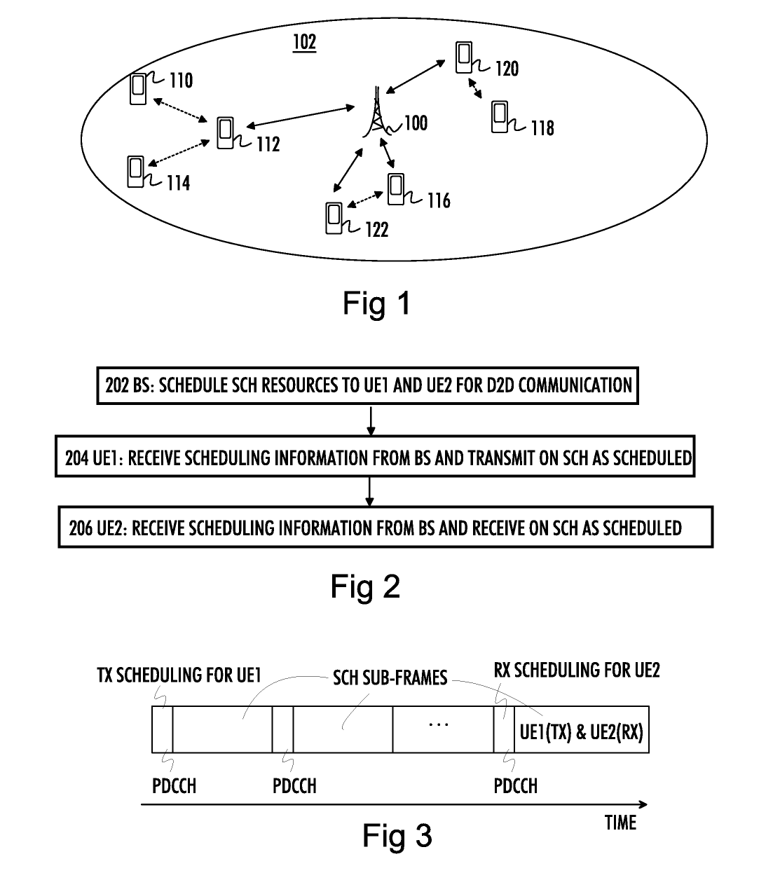

FIG. 1 illustrates communication links in a cell 102 of a mobile telecommunication system according to an embodiment of the invention. Referring to FIG. 1, the cell 102 is associated with a base station 100 controlling communications within the cell 102. The cell 102 controlled by the base station 100 may be divided into sectors, but such a scenario is not illustrated in greater detail in order to keep the focus on the invention. The base station 100 may control cellular radio communication links established between the base station 100 and a plurality of terminal devices 110 to 122 located within the cell 102.

As noted in the background section, device-to-device connections may be established among the terminal devices 110 to 122. Let us now discriminate the cellular radio connections from the device-to-device connections by denoting that the cellular radio connections include data transfer through the cellular network infrastructure, while device-to-device connections are established directly between two terminal devices without routing data through the base station 100 or any other part of a fixed network infrastructure of a mobile telecommunication system. In other words, the terminal devices communicate with each other on a physical and link levels.

Both cellular and device-to-device communication links may be established and operated according to a given radio standard supported by the mobile communication system of the base station 100. Such a standard may be the Long-Term Evolution (Advanced) of the UMTS (Universal Mobile Telecommunication System) or another evolution version of the UMTS, e.g. high-speed packet access (HSPA). However, embodiments of the invention may be applicable to any other advanced cellular telecommunication system utilizing dynamic scheduling of shared communication resources and supporting integrated in-band device-to-device communication on the shared communication resources.

According to an embodiment of the present invention, direct device-to-device communication is controlled between a first and at least a second terminal device on a shared communication channel used also for communication with a base station. The base station schedules the utilization of the shared communication channel to terminal devices communicating with the base station and terminal devices communicating directly with one another.

FIG. 2 illustrates how the communication control is implemented from a point of view of the base station, a first terminal device, and a second terminal device.

Referring to block 202, the base station controls the direct device-to-device communication between the first and the second terminal device by scheduling communication resources and a transmission time interval on the shared communication channel to the first and the second terminal device. In other words, the base station (or another element of the fixed network infrastructure) is in control of the communication resource of the shared communication channel, and the shared communication channel is used for exchanging data with the base station and for communicating data over the device-to-device connection.

Referring to block 204, the first terminal device controls its communication on the shared communication channel on the basis of scheduling messages received from the base station on a control channel, e.g. a physical downlink control channel (PDCCH) of the LTE UMTS. Let us consider an example where the base station schedules the first terminal device to transmit and the second terminal device to receive. In block 204, the first terminal device receives a scheduling message from the base station, extracts the scheduling message, and determines the communication resources scheduled to it for transmission.

Then, the first terminal device initiates processing of transmission data for transmission in the scheduled communication resources, including data encoding and modulation. Referring to block 206, the second terminal device receives a scheduling message from the base station, extracts the scheduling message, and determines the communication resources scheduled to it for reception.

Then, the second terminal device configures its radio receiver components to receive data from the first terminal device in the scheduled communication resources.

The base station may indicate the scheduling to the first and second terminal devices in separate scheduling messages or in the same scheduling message. Let us now consider the scheduling in greater detail with reference to FIG. 3. The scheduling of the shared communication resources to device-to-device communication may be done in a manner very similar to conventional scheduling used in the LTE UMTS system. The PDCCH may be used to carry the scheduling messages for both cellular and device-to-device connections, and the indication of the scheduled communication resources and transmission time interval may be done as in the LTE specifications. A special field may be added to the scheduling message to indicate whether the scheduling applies to the device-to-device connection or to the cellular connection. We will return to this later.

FIG. 3 illustrates a downlink frame structure of the LTE system, wherein a radio frame comprises 10 sub-frames.

Each sub-frame represents communication resources of a shared communication channel, and one or more terminal devices may be scheduled to carry out communication in each sub-frame. In the downlink, the LTE UMTS utilizes orthogonal frequency division multiple access (OFDMA) where one or more resource blocks, each comprising a plurality of OFDM sub-carriers, can be scheduled to a given terminal device. In the uplink, the LTE UMTS utilizes single-carrier frequency division multiple access (SCFDMA) which can be seen as a pre-coded OFDM scheme resulting in better peak-to-average power ratios in transmission, which is advantageous in mobile uplink transmission due to lower power consumption. Similarly, one or more SC-FDMA resource blocks can be scheduled to a given terminal device for uplink cellular transmission or for device-to-device transmission. In practice, either OFDMA or SC-FDMA transmission (or another radio access scheme) may be used in the device-to-device communications in the scheduled resources. Each sub-frame in FIG. 3 is preceded by a physical downlink control channel portion carrying the scheduling messages, among others. In the LTE uplink, the base station schedules for uplink cellular transmission four sub-frames before the actual transmission time interval so that a scheduled terminal device can prepare data for the transmission. In the LTE downlink, the base station schedules downlink cellular transmission in the PDCCH preceding the scheduled sub-frame and, thus, the scheduled downlink transmission occurs in the next sub-frame following the PDCCH comprising the scheduling message. In consequence, the scheduled terminal device receives the scheduled communication resources following immediately after the scheduling message addressed to the terminal device.

Referring to FIG. 3, a similar approach is applied to scheduling in-band device-to-device connections utilizing the same shared communication channel sub-frames as the cellular communication links. Let us again consider the case where the first terminal device is transmitting and the second terminal device is receiving data from the first terminal device. The base station transmits a scheduling message to the first terminal device in a first PDCCH slot and, upon detection of the scheduling message and determination of the scheduled resource blocks, the first terminal device starts to process data for transmission. During the next four sub-frames following the first PDCCH slot, the first terminal device prepares for the transmission in the fifth sub-frame counted from the first PDCCH slot. In a fifth PDCCH slot, the base station transmits a scheduling message to the second terminal device, indicating reception and the same communication resources already scheduled to the first terminal device in the first PDCCH slot. Upon detection of the scheduling message, the second terminal device configures its receiver components to receive data from the first terminal in the fifth sub-frame. In the fifth sub-frame, the first terminal device transmits and the second terminal device receives the data in the scheduled resource block(s).

The scheduling messages may also carry an indication whether a given terminal device is scheduled to transmit or receive in the scheduled communication resources. The indication of the transmission direction may be provided explicitly or implicitly.

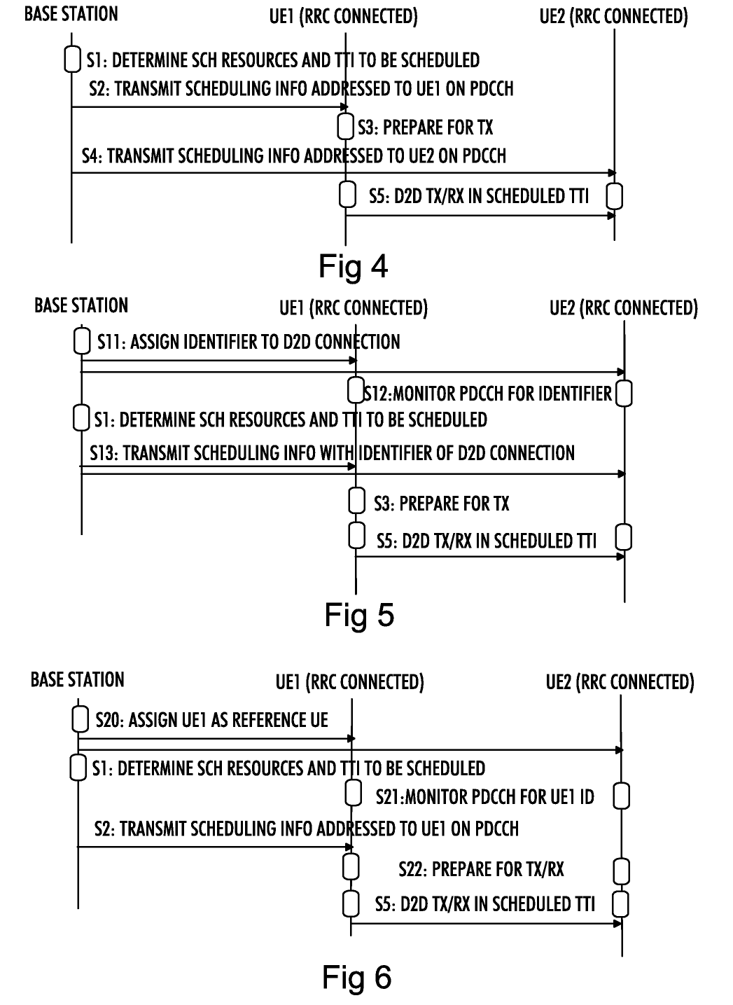

FIGS. 4 to 6 illustrate embodiments for indicating the scheduling to the terminal devices scheduled to communicate with each other by using given communication resources. According to the embodiments, the scheduling message may be addressed to each terminal device separately (FIG. 4), it may be addressed to an identifier dedicated to a given device-to-device link or links (FIG. 5), or it may be addressed to a reference terminal device and the other terminal devices of the same link also receive the scheduling message (FIG. 6).

Referring to a signaling diagram of FIG. 4, a first terminal device (UE1) and a second terminal device (UE2) are communicating with each other over a device-to-device radio link allocated to the same frequency band that a base station utilizes for cellular communications. The frequency band includes a shared communication channel (SCH) that the base station schedules for utilization by both the cellular communications and device-to-device communications. In order to enable the scheduling, both UE1 and UE2 establish a control channel connection with the base station, i.e. they remain in a radio resource control (RRC) connected state even though they are not transmitting any data over cellular links. Let us now consider a single scheduling operation, wherein the base station schedules resources of the shared communication channel dynamically to UE1 and UE2. In S1, the base station determines SCH resources to be allocated to the device-to-device connection between UE1 and UE2. The base station may initiate S1 upon reception of a scheduling request indicator from UE1, wherein the scheduling request indicator indicates that UE1 is requesting transmission. The scheduling request indicator may also indicate that the request is related to the device-to-device connection.

S1 may include selection of physical resource blocks, e.g. frequency sub-bands, and a transmission time interval, e.g. sub-frame, for UE1 and UE2. In S2, the base station transmits a scheduling message addressed to UE1 on the PDCCH, i.e. the scheduling message comprises an identifier of UE1 (a cellular network temporary identifier, C-RNTI, for example). The scheduling message comprises the information determined in S1 and, thus, indicates the resources of the SCH scheduled to UE1 for transmission. S2 may be carried out well in advance of the scheduled transmission time interval so that UE1 has time to process data for transmission in S3, e.g. to encode, modulate, and carry out other signal processing needed in the transmission. However, it can be envisaged that UE1 has carried out the signal processing in advance and is ready for transmission as soon as it receives the scheduling message. A transport format including link adaptation parameters, e.g. a modulation and coding scheme, may have been determined beforehand. In such a case, the base station may transmit the scheduling message in a PDCCH slot immediately preceding the scheduled sub-frame. In this case, the scheduling message may be transmitted to both a transmitter (UE1) and a receiver (UE2) in the PDCCH of the same transmission time interval or sub-frame.

In S4, the base station transmits a scheduling message addressed to UE2 on the PDCCH. The scheduling message may comprise a C-RNTI of UE2 in order to indicate the destination of the scheduling message. This scheduling message may be transmitted in the PDCCH slot immediately preceding the scheduled sub-frame. Now that both UE1 and UE2 have been provided with the scheduling message and are aware of the scheduled communication resources, device-to-device transmission is carried out in S5, wherein UE1 transmits a physical data packet in the scheduled communication resources, and UE2 receives the physical data packet in the same scheduled communication resources.

As already mentioned above, the scheduling messages provided by the base station may comprise a field having bit values indicating the transmission direction in the scheduled device-to-device transmission. Upon reading the field, UE1 or UE2 obtains knowledge about whether it is scheduled to transmit or receive. This is an example of explicit signaling of the transmission direction, wherein the base station explicitly indicates for each terminal device whether it is scheduled to transmit or receive. The indication may be done by using a transmission/reception flag in the scheduling message. An example of an implicit method for indicating the transmission direction utilizes the duplexing method used in the device-to-device link. In connection with pairing the terminal devices for device-to-device connection and negotiating the RRC connection with the base station, the duplexing scheme is also negotiated for the device-to-device link. In the negotiation of the duplexing scheme, the base station may allocate to each terminal device a specific set of resources to be used in the transmission and another set of resources to be used in the reception, wherein the two sets of specific resources do not overlap. Naturally, the other terminal device of the device-to-device link uses the same resources in the opposite direction. The transmission and reception resources may be separated in frequency (frequency-division duplexing, FDD) or in time (time-division duplexing, TDD). As a consequence, the terminal device may deduce from the scheduled communication resource whether it is scheduled to transmit or receive. If the scheduled communication resources belong to the set of transmission resources, the terminal device knows it is scheduled to transmit. Similarly, if the scheduled communication resources belong to the set of reception resources, the terminal device knows it is scheduled to receive.

Another example of indicating the transmission direction implicitly utilizes different formats of downlink control information (DCI) already in use in the LTE UMTS. The formats of the DCI transmitted on the PDCCH include 1, 1A, 1B, 1C, and 2. The transmission direction may be indicated with the format of the scheduling message. For example, if a scheduling message is addressed to UE1 in format 1, UE1 is scheduled to transmit, while a scheduling message in format 2 indicates reception. Additionally, a field indicating that the scheduling message is related to the device-to-device link may be included in the scheduling message in order to enable discrimination between the cellular links and the device-to-device links.

Let us consider another embodiment for signaling the scheduling messages with reference to FIG. 5. In this scenario, the base station allocates a dedicated identifier to the device-to-device link. If the device-to-device link is a multicast link comprising a plurality of physical device-to-device links between more than two terminal devices, the dedicated identifier may refer to the logical multicast connection and not to individual physical links so as to optimize the utilization of the identifiers. In S11, the base station assigns to UE1 and UE2 the same identifier to be used when addressing the device-to-device communication link. S11 may be carried out in connection with establishing the RRC connection for the device-to-device link. In S12, both UE1 and UE2 monitor the PDCCH for the presence of the identifier assigned in S11. Let us again assume that the base station schedules UE1 to transmit and UE2 to receive. In S1, the base station determines the SCH resources to be scheduled for the device-to-device link between UE1 and UE2.

In S13, the base station transmits a scheduling message indicating the communication resource determined in S1 to UE1 and UE2, wherein the scheduling message comprises the identifier assigned in S11 so as to indicate that the scheduling message is addressed to UE1 and UE2. In this example, the same single scheduling message may be used to indicate both transmission and reception scheduling. A scheduled transmission time interval may be indicated explicitly in the scheduling message, or UE1 and UE2 may derive the scheduled transmission time interval from the timing of the scheduling message, e.g. fifth sub-frame counted from the PDCCH time slot carrying the scheduling message. In S3, UE1 prepares to make the transmission, and UE1 transmits and UE2 receives a data packet in the scheduled resources in S5.

In this example, each terminal device monitors the PDCCH for the identifier assigned to the device-to-device connection instead of monitoring for its own C-RNTI.

Explicit signaling of the transmission direction may naturally be used, as in previous examples. Implicit indication of the transmission direction on the basis of the duplexing method and scheduled communication resources may also be used. In case the device-to-device connection is a multicast connection, explicit signaling may be used.

When establishing the RRC connection of the multicast device-to-device connection, a short temporary identifier may be assigned to each terminal device of the multicast connection. Each scheduling message may comprise a field carrying the short identifiers as being associated with a transmission/reception flag. As a consequence, the scheduling message may indicate explicitly for each terminal device whether it is scheduled to transmit or receive. In an alternative embodiment, the scheduling message may comprise the short identifier of the transmitting terminal device and the transmission/reception flag. The other terminal device may deduce, upon reading the short identifier of the transmitting terminal device in connection with the transmission/reception flag that they are scheduled to receive. The short identifier may have a length corresponding to the maximum supported number of parties in a multicast connection. For example, if the maximum number of parties of a multi-cast connection is 16, the short identifier may have a length of four bits so that each terminal device may be assigned with a different short identifier. In any case, the short identifier may be shorter than the C-RNTI used for addressing the terminal devices in the cellular network.

In the embodiment of FIG. 6, one of the terminal devices paired for the device-to-device connection is assigned as a reference terminal device, and all scheduling messages of the device-to-device connection are addressed to the reference terminal device. The other terminal devices monitor the PDCCH for the C-RNTI of the reference terminal device to acquire the scheduling messages. Let us in this example assume that UE1 is the reference terminal device.

In S20, the base station assigns UE1 as the reference terminal device for scheduling purposes. S20 may be carried out in connection with establishing the RRC connection for the device-to-device link. In S1, the base station determines the SCH resources to be scheduled for the device-to-device link between UE1 and UE2. In S21, UE1 and UE2 monitor the PDCCH for the C-RNTI (or another identifier) of UE1. UE1 and UE2 may carry out step S21 while the base station carries out step S1. In S2, the base station transmits a scheduling message containing the C-RNTI of UE1. Both UE1 and UE2 read the scheduling message and its contents to determine the scheduled communication resources and, then, UE1 prepares to transmit and UE2 prepares to receive in the scheduled communication resources in S22. In S5, the transmission/reception is carried out in the scheduled communication resources.

The indication of the transmission direction may be provided as in the embodiment of FIG. 5, e.g. through explicit signaling, the duplexing method, or by using short identifiers.

Above, we have considered situations where the terminal devices communicate over the device-to-device connection by using the same frequency band and the same shared communication channel as the cellular links. However, the device-to-device communication links may also utilize frequency bands outside the frequency bands of the cellular communication system. Let us consider a case where a terminal device is using both in-band and out-band resources. When the terminal device is receiving data on out-band frequency resources, it may not be able to receive the PDCCH and it may miss a scheduling message addressed to it. This reduces the efficiency of the utilization of the shared communication channel, because the communication resources scheduled to the terminal device will not be used. In an embodiment, the terminal devices inform the base station about out-band transmission timings so that the base station is configured to prevent transmission of scheduling messages to the terminal device carrying out out-band reception in those PDCCH time slots in which the reception is carried out. Accordingly, wasting the scheduled resources due to incapability to receive the scheduling message is avoided.

Scheduling may also be affected by the out-band transmissions so that a given terminal device is not scheduled to transmit on the shared communication channel simultaneously with out-band transmission. Statistically, the interruption in scheduling and transmission of the scheduling messages may be alleviated if the base station is configured to schedule more frequency resource blocks less frequently to the terminal devices known also to perform out-band transmissions. In practice, the base station may reduce the number of scheduled transmission time intervals and increase the number of frequency resource blocks of the SCH allocated to a given terminal device when it detects that the terminal device is communicating on a frequency band outside the frequency band allocated to the base station.

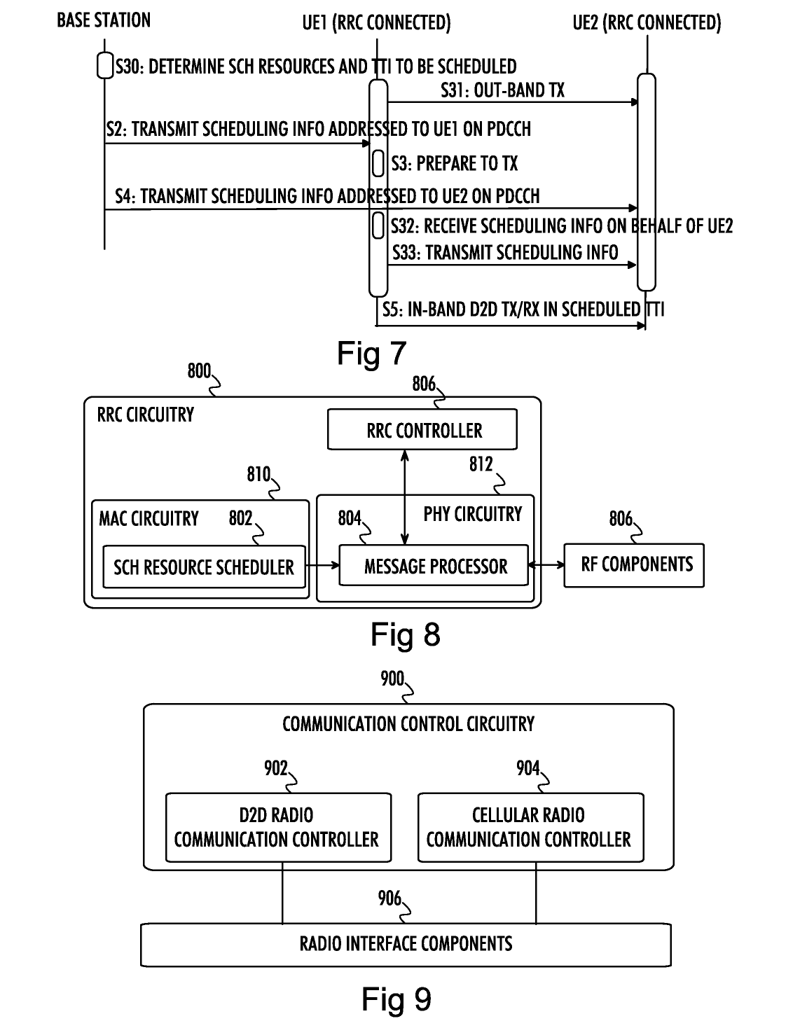

In another embodiment, a transmitting terminal device carrying out the out-band transmission may be configured to receive the scheduling message on behalf of the receiving terminal device. A procedure according to this embodiment will now be described with reference to FIG. 7. In S30, the base station determines the SCH resources to be scheduled for the device-to-device link between UE1 and UE2. The base station may take into account the out-band transmissions of UE1 and UE2 in S30 so that a transmission time interval to be scheduled to UE1 and UE2 does not overlap with transmission timing used for the out-band transmission between UE1 and UE2. An additional guard interval after the end of the out-band transmission may also be provided in order to ensure that UE1 and UE2 are prepared to utilize the scheduled resources.

In S31, UE1 carries out an out-band transmission to UE2, and UE2 receives the out-band transmission simultaneously.

The out-band transmission may occur on another licensed cellular frequency band controlled by another base station, or it may be carried out on an unlicensed frequency band, in which case the terminal devices UE1 and UE2 control the scheduling of transmissions. The base station may be informed about the transmission timing of the out-band transmission by one of the terminal devices UE1 and UE2 or by the other base station controlling the out-band transmissions.

Now, UE2 is tuned for out-band reception and is not able to receive a scheduling message from the base station.

Meanwhile, UE1 carrying out the out-band transmission is also aware that UE2 cannot receive the PDCCH and, therefore, UE1 is configured to monitor the PDCCH for a scheduling message carrying C-RNTI of either UE1 or UE2.

In S2, the base station transmits a scheduling message related to the execution of S30 to UE1 in order to configure UE1 for transmission in the scheduled communication resources. In response to the reception of the scheduling message, UE1 prepares in S3 to transmit data in the scheduled SCH resources. In S4, the base station transmits a scheduling message related to the execution of S30 to UE2 in order to configure UE2 for reception in the scheduled communication resources.

However, UE2 is not able to receive the scheduling message due to simultaneous out-band reception. Therefore, UE1 is configured to receive the scheduling message on behalf of UE2 in S32. UE1 and UE2 are carrying out the out-band transmission during the steps S2 to S32 of FIG. 7. In S33, UE1 may include the scheduling message in the out-band transmission to UE2 in order to deliver the scheduling message to UE2. UE1 may cut out a portion of data it intended to transmit on the out-band to UE2 or it may add the scheduling message to the data in the out-band transmission. On the other hand, UE2 is configured to detect the scheduling message within the data received on the out-band, extract the scheduling message and associate it with the in-band transmission. As a consequence, UE2 receives the scheduling message during the out-band reception on the out-band and can prepare for the in-band reception from UE1. In S5, UE1 and UE2 communicate over the scheduled in-band communication resources.

The embodiment of FIG. 7 is described in the context of transmitting separate scheduling messages to UE1 and UE2, but the embodiment utilizing the reception of a scheduling message on behalf of another terminal device may be applied to any method for transmitting the scheduling messages. Accordingly, the base station may transmit a single scheduling message as being addressed to a reference terminal device (embodiment of FIG. 6) or to a temporary identifier assigned to the device-to-device connection (embodiment of FIG. 5), and a first terminal device carrying out out-band transmission may receive the scheduling message on behalf of a second terminal device carrying out reception from the first terminal device on the out-band.

Furthermore, the embodiment of FIG. 7 shows that the terminal device transmitting the out-band transmission receives the scheduling message on behalf of the receiving terminal device. However, it is not necessary that the transmitting terminal device receives the scheduling message on behalf of the receiving terminal device. In another embodiment, another terminal device aware of the fact that the receiving terminal device is carrying out out-band reception may receive the scheduling message on behalf of the receiving terminal device and transmit the scheduling message to the receiving terminal device as soon as possible.

In an embodiment, link adaptation of the device-to-device connection is controlled between the terminal devices without intervention from the base station. The terminal devices may exchange channel state information related to a radio channel between the terminal devices, and select link adaptation parameters on the basis of the channel state information. The link adaptation parameters may include at least one of the following: a modulation and coding scheme, a puncturing pattern, and a multi-antenna transmission scheme. The multi-antenna transmission scheme may include selection between spatial multiplexing and beamforming, for example. Enabling the terminal devices to negotiate the link adaptation parameters without intervention by the base station reduces signaling overhead in the cellular link, because there is no need to transmit the channel state information to the base station. In another embodiment, the base station controls the link adaptation parameters of the device-to-device connections. The terminal devices may be configured to transmit channel state information related to the radio channel between the terminal devices, and the base station may be configured to select the link adaptation parameters for the device-to-device connection and to configure the terminal devices to apply the selected link adaptation parameters.

FIGS. 8 and 9 illustrate two types of apparatus configured to carry out the embodiments of the invention.

The apparatuses comprise a communication control circuitry configured to control device-to-device communication between a first and at least a second terminal device on a shared communication channel used also for communication with a base station, wherein the base station schedules the utilization of the shared communication channel to terminal devices communicating with the base station and terminal devices communicating directly with one another.

The communication control circuitry may be implemented by one or more processors which may be driven by software (or firmware), or they may be hardware processors, e.g. ASIC.

Naturally, a combination of software and hardware processors is a possible implementation. The processor(s) may include single-core processors and/or multi-core processors. The communication control circuitry is applicable to a radio communication device comprising the communication control circuitry and a radio communication circuitry. Additionally, the radio communication device may include one or more memory units to store software configuring the operation of the radio communication device as well as other data.

When the apparatus is applied to the base station, the communication control circuitry may be embodied by a radio resource control (RRC) circuitry 800 (FIG. 8). The RRC circuitry may comprise an RRC controller 806 configured to establish, maintain, and terminate RRC connections with terminal devices under the control of the base station.

The RRC controller may be a higher level controller (Layer 3) communicating with the terminal devices through a message processor 804 and radio frequency components 806 of the base station. A medium access control (MAC) circuitry 810 of the base station comprises an SCH resource scheduler 802 configured to schedule SCH resources to the terminal devices. The SCH resource scheduler is configured to schedule the SCH resources dynamically to both the cellular links and the device-to-device links. The resource scheduler may schedule both physical resource blocks (sub-bands) and transmission time intervals to the terminal devices. The time resolution of the scheduling may depend on the system specification, and it may be a sub-frame or a time slot, for example. In any case, the time resolution should be so high that dynamic and efficient utilization of the SCH resources is achieved, e.g. in the order of milliseconds, thus optimizing the capacity of the system. In order to enable fast scheduling, the SCH resource scheduler may be embodied in the MAC circuitry. The SCH resource scheduler may apply the scheduling information determined for a given terminal device to the message processor 804 comprised in a physical layer circuitry 812. The message processor 804 is configured to build control channel messages from control information received from the RRC controller 806 and the SCH resource scheduler and transmit the control messages, including the scheduling messages, to the terminal devices through radio frequency (RF) components 806. The message processor 804 may also perform modulation, coding, and other digital signal processing functions for the control messages. On the other hand, the message processor 804 may be configured to receive control channel messages from the terminal devices through the RF components 806, extract the messages, and convey control information comprised in the control messages to the SCH resource scheduler 802 and the RRC controller 806. The message processor 804 may convey scheduling request indicators, for example, to the SCH resource scheduler 802 and higher layer control messages to the RRC controller 806. The RF components may comprise circuitry configured to perform analog signal processing functions for transmitted or received signals, including filtering, frequency-conversion, amplification, etc.

FIG. 8 illustrates a functional block diagram of the structure of the apparatus according to an embodiment of the invention, wherein the apparatus is applied to a terminal device of a mobile telecommunication system, e.g. UE1 and UE2. The terminal device comprises communication control circuitry 900 configured to control both cellular and device-to-device communication links in the terminal device. The communication control circuitry 900 may include two sub-controllers, namely a device-to-device communication controller 902 and a cellular radio communication controller 904. The cellular radio communication controller 904 may control establishment, operation, and termination of the cellular links with a serving base station of the mobile telecommunication system. The cellular radio communication controller 904 may control both control and data connections with the base station according to the specifications of the mobile telecommunication system. In order to enable in-band device-to-device communication, the cellular radio communication controller 904 may be configured to establish the RRC connection with the serving base station, receive scheduling messages from the base station and convey the scheduling messages to the device-to-device communication controller either directly or through other components of the communication control circuitry 900.

Additionally, the cellular radio communication controller 904 may be configured to convey scheduling requests to the base station in order to request for scheduling of SCH communication resources for at least one of cellular or device-to-device communications. The scheduling requests may comprise an indicator indicating whether the request is related to the cellular or device-to-device communications. The cellular radio communication controller 904 may also be configured to carry out digital signal processing functions for cellular control or data signals transmitted from or received in the terminal device.

The device-to-device radio communication controller 902 may be configured to control in-band device-to-device transmission and reception on the basis of scheduling information received through the cellular radio communication controller 904. Additionally, the device-to-device radio communication controller 902 may be configured to control out-band communications according to a communication scheme used in the particular frequency band. The device-to-device radio communication controller 902 may be a cognitive controller configured to adaptively select a radio communication scheme on the basis of the frequency band and other radio environment parameters. For example, the device-to-device radio communication controller 902 may apply a cellular radio communication scheme (OFDMA or SC-FDMA) to in-band transmissions and another radio communication scheme in out-band transmissions.

The terminal device also comprises radio interface components 906 coupled to the communication control circuitry 900 and configured to perform analog signal processing functions for transmitted or received signals, including filtering, frequency-conversion, amplification, etc.

The processes or methods described in connection with FIGS. 2 and 4 to 7 may also be carried out in the form of a computer process defined by a computer program. The computer program may be in source code form, object code form, or in some intermediate form, and it may be stored in a physical carrier, which may be any entity or device capable of carrying the program. Such carriers include a record medium, computer memory, read-only memory, electrical carrier signal, telecommunications signal, and software distribution package, for example. Depending on the processing power needed, the computer program may be executed in a single electronic digital processing unit or it may be distributed amongst a number of processing units.

The present invention is applicable to cellular or mobile telecommunication systems defined above but also to other suitable telecommunication systems. The protocols used, the specifications of mobile telecommunication systems, their network elements and subscriber terminals, develop rapidly. Such development may require extra changes to the described embodiments. Therefore, all words and expressions should be interpreted broadly and they are intended to illustrate, not to restrict, the embodiment.

It will be obvious to a person skilled in the art that, as technology advances, the inventive concept can be implemented in various ways. The invention and its embodiments are not limited to the examples described above but may vary within the scope of the claims.

1. A method, comprising:
controlling direct device-to-device communication between a first and at least a second terminal device on a shared communication channel also used for communication with a base station, wherein the base station schedules the utilization of the shared communication channel to terminal devices communicating with the base station and terminal devices communicating directly with one another.

2. The method of claim 1, further comprising: using the same control channel for carrying information on scheduling of both communication with the base station and direct device-to-device communication between terminal devices.

3. The method of claim 1, further comprising:
utilizing a control channel message conveyed on the control channel carrying the scheduling information, wherein the control channel message comprises an identifier of a scheduled terminal device and information transmission resources in which the scheduled terminal device is scheduled to communicate.

4. The method of claim 1, wherein a format of the control channel message indicates implicitly whether the scheduling relates to transmission or reception of data.

5. The method of claim 1, wherein a device-to-device connection is provided with a dedicated identifier, the method further comprising: utilizing a control channel message conveyed on the control channel carrying the scheduling information, wherein the control channel message comprises the dedicated identifier and information on transmission resources in which the terminal devices associated with the dedicated identifier are scheduled to communicate.

6. The method of claim 1, further comprising: utilizing the same control channel message for all the terminal devices communicating together by using one or more direct device-to-device connections, the control channel message being conveyed on the control channel carrying the scheduling information, wherein the control channel message comprises an identifier of one of the scheduled terminal devices and information on transmission resources in which the terminal devices are scheduled to communicate.

7. The method of claim 5, wherein the control channel message comprises a unique identifier for each terminal device communicating together by using one or more direct device-to-device connections and an indicator associated with each unique identifier and indicating transmission or reception in the scheduled transmission resources.

8. The method of claim 1, further comprising:
allocating a first set of transmission resources for transmission and a second set of transmission resources for reception to a given terminal device, wherein the first and second sets of transmission resources are different from one another; and
indicating to the terminal device whether to transmit or receive in the scheduled transmission resources implicitly on the basis of whether the scheduled transmission resources belong to the first set of transmission resources or to the second set of transmission resources.

9. The method of claim 1, further comprising:
determining, in a first terminal device, whether the second terminal device is performing reception on a frequency band different from that used for transmitting the shared communication channel;
if the second terminal device is determined to perform the reception on a different frequency band, receiving in the first terminal device on behalf of the second terminal device scheduling information related to the shared communication channel and addressed to the second terminal device; and
transmitting the scheduling information to the second terminal device in order to enable the second terminal device to carry out the scheduled communication on the shared communication channel.

10. The method of claim 1, further comprising:
negotiating at least part of link adaptation parameters for the direct device-to-device connection between the terminal devices communicating over the direct device-to-device connection without the base station affecting the negotiated link adaptation parameters.

11. An apparatus comprising:
communication control circuitry configured to control direct device-to-device communication between a first and at least a second terminal device on a shared communication channel also used for communication with a base station, wherein the base station schedules the utilization of the shared communication channel to terminal devices communicating with the base station and terminal devices communicating directly with one another.

12. The apparatus of claim 11, wherein the communication control circuitry is further configured to use the same control channel for carrying information on scheduling of both communication with the base station and direct device-to-device communication between terminal devices.

13. The apparatus of claim 11, wherein the communication control circuitry is further configured to utilize a control channel message conveyed on the control channel carrying the scheduling information, wherein the control channel message comprises an identifier of a scheduled terminal device and information transmission resources in which the scheduled terminal device is scheduled to communicate.

14. The apparatus of claim 11, wherein a format of the control channel message indicates implicitly whether the scheduling relates to transmission or reception of data.

15. The apparatus of claim 11, wherein a device-to-device connection is provided with a dedicated identifier and wherein the communication control circuitry is further configured to utilize a control channel message conveyed on the control channel carrying the scheduling information, wherein the control channel message comprises the dedicated identifier and information on transmission resources in which the terminal devices associated with the dedicated identifier are scheduled to communicate.

16. The apparatus of claim 11, wherein the communication control circuitry is further configured to utilize the same control channel message for all the terminal devices communicating together by using one or more direct device-to-device connections, the control channel message being conveyed on the control channel carrying the scheduling information, wherein the control channel message comprises an identifier of one of the scheduled terminal devices and information on transmission resources in which the terminal devices are scheduled to communicate.

17. The apparatus of claim 15, wherein the control channel message comprises a unique identifier for each terminal device communicating together by using one or more direct device-to-device connections and an indicator associated with each unique identifier and indicating transmission or reception in the scheduled transmission resources.

18. The apparatus of claim 11, wherein a first set of transmission resources is allocated to the first terminal device for transmission and to the second terminal device for reception, and a second set of transmission resources is allocated to the first terminal device for reception and to the second terminal device for transmission, wherein the first and second sets of transmission resources are different from one another, and wherein the communication control circuitry is configured to determine whether a given terminal device is configured to transmit or receive in the scheduled transmission resources implicitly on the basis of whether the scheduled transmission resources belong to the first set of transmission resources or to the second set of transmission resources.

19. The apparatus of claim 11, wherein the communication control circuitry is applicable to the first terminal device and further configured to determine whether the second terminal device is performing reception on a frequency band different from that used for transmitting the shared communication channel; if the second terminal device is determined to perform the reception on a different frequency band, to receive on behalf of the second terminal device scheduling information related to the shared communication channel and addressed to the second terminal device; and to transmit the scheduling information to the second terminal device in order to enable the second terminal device to carry out the scheduled communication on the shared communication channel.

20. The apparatus of claim 11, wherein the communication control circuitry is applicable to the first terminal device and is further configured to negotiate at least part of link adaptation parameters for the direct device-to-device connection with at least the second terminal device communicating over the direct device-to-device connection without the base station affecting the negotiated link adaptation parameters.

21. An apparatus comprising means for executing the method of claim 1.

22. A base station of a mobile telecommunication system comprising the apparatus according to claim 11 and radio frequency components configured to enable the base station to communicate over a radio channel.

23. A terminal device of a mobile telecommunication system comprising the apparatus according to claim 11 and radio interface components configured to enable the terminal device to communicate over a radio channel.

24. An apparatus, comprising:
means for controlling direct device-to-device
communication between a first and at least a second terminal device on a shared communication channel also used for communication with a base station, wherein the base station schedules the utilization of the shared communication channel to terminal devices communicating with the base station and terminal devices communicating directly with one another.

25. A computer program product embodied on a physical carrier medium readable by a computer and comprising program instructions which, when loaded into an apparatus, execute the method according to claim 1.
